(19) United States
(12) Patent Application Publication
(10) Pub. No.: US 2002/0043346 A1
(43) Pub. Date: Apr. 18, 2002

(54) Pleated blind

(76) Inventor: Tass Zorbas, Bedfordale (AU)

Correspondence Address: Gregory P. LaPointe, BACHMAN & LaPOINTE, P.C., Suite 1201, 900 Chapel Street, New Haven, CT, 06510-2802, US

(21) Appl. No.: 09/919,203

(22) Filed: Jul. 31, 2001

(30) Foreign Application Priority Data
Jul. 31, 2000 (AU) PQ9080

(51) Int. Cl. E06B 3/48

(52) U.S. Cl. 160/84.05

(57) ABSTRACT

A pleated blind having a plurality of flexible tubular fabric slats connected together in side by side relationship. The slats may be adhered together by any suitable means. The slats may be flattened and then allowed to expand under the influence of gravity.

### FIELD OF INVENTION

The present invention relates to a pleated blind.

### BRIEF DESCRIPTION OF THE INVENTION

In accordance with one aspect of the present invention there is provided a pleated blind comprising a plurality of flexible tubular fabric slats in which adjacent slats are connected together contiguously in side by side relationship.

### BRIEF DESCRIPTION OF THE DRAWINGS

The present invention will now be described, by way of example, with reference to the accompanying drawings, in which:

FIG. 1 is an upper perspective view of part of a fabric tube slat used to manufacture a pleated blind in accordance with the present invention;

FIG. 2 is an upper perspective view similar to FIG. 2 showing two of the fabric tube slats adhered together; and

FIG. 3 is an end view of a pleated blind in accordance with the present invention made from the fabric blind slats of FIGS. 1 and 2 in expanded condition.

### DESCRIPTION OF THE INVENTION

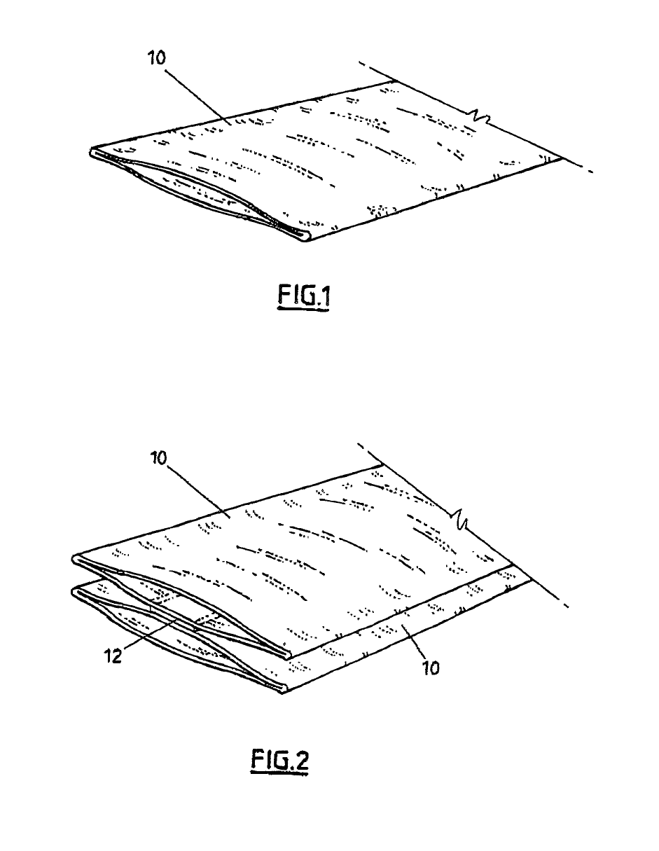

In FIG. 1 of the drawings, there is shown part of a flexible fabric tube slat 10 formed of a woven fabric material. Further, the fabric tube slat 10 may be fabricated from yarn on a narrow weaving loom. The fabric material is preferably polyester fabric produced from polyester yarn. The fabric tube slat 10 as seen in FIG. 1 has an endless periphery and does not contain any longitudinal joints.

As can be seen in FIG. 2, in accordance with the present invention, adjacent fabric tube slats 10 are adhered together in contiguous side by side relationship such as by means of adhesive tapes 12.

Further, fabric tubes from the weaving loom are preferably coated with a non-stick coating such as an acrylic coating. The non-stick coating has the advantage of preventing the fabric tube slats 10 from sticking to one another inadvertently and also assists in prevention of fraying of ends of the fabric tube slats 10 if the fabric tube slats 10 are cut during fabrication. Also, it is envisaged that the fabric tube slats 10 would be formed with holes such as by punching or drilling to accommodate cords from which a blind is suspended in use. The non-stick coating helps prevent fraying of these holes.

Preferably, the fabric tube is initially produced in elongated form from the weaving loom and then cut to length as required to form the fabric tube slats 10.

The fabric tube may be finished using a narrow coating or finishing line which may involve various steps such as dipping of the fabric tube in a bath of coating material and then drying and callandering. The finished elongated fabric tube is typically then formed into a roll in which the fabric tube is in flattened form.

Subsequently, the fabric tube 10 is provided with adhesive means which may be in the form of double sided adhesive tape 12 shown in FIG. 2. The double sided adhesive tape 12 may be applied externally to a fabric tube at two opposed locations with one side of the tape 12 protected to avoid inadvertent sticking of the tape 12. The double sided tape 12 will be of a width smaller than the flattened fabric tube. For example, a flattened fabric tube which is about 50 mm wide may require an adhesive tape which is from 3 to 10 mm wide such as about 5 mm wide.

Double sided adhesive tapes 12 may be applied in a suitable apparatus to the centre of the flattened fabric tube from the roll both top and bottom in opposed locations. Subsequently, the fabric tube and the tapes may be guided through a station where they are passed through, for example, pressure rollers so that a strong bond is formed between the tapes 12 and the fabric tube 10.

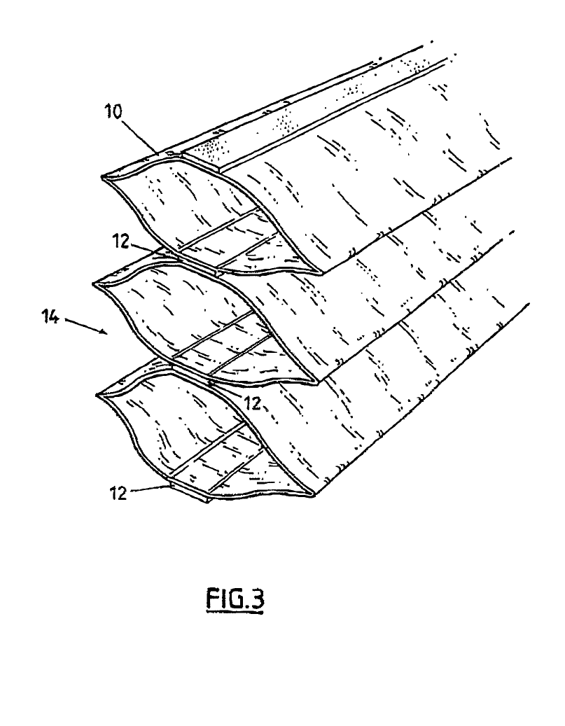

To form a pleated blind 14 as shown in FIG. 3, the fabric tube with tapes 12 is cut into desired lengths to form the flexible fabric tube slats 10. A protective covering is removed from each tape 12. Then a tape 12 of a similar type is pressed into engagement with the first mentioned blind slat 10 so that two blind slats 10 may be adhered together by means of the adhesive tapes 12. This process is repeated until the desired blind size is achieved. The pleated blind 14 can be finished off by means known in the art.

It is envisaged that the pleated blind 14 will be sold in a roll with the fabric tube slats 10 in flattened form. The user will then form the blind 14 into the finished product to suit a particular application. In use the plated blind 14 is suspended and allowed to expand as shown in FIG. 3 so as to enable it to cover a window or door opening as the like.

The adhesive tapes described hereinbefore can be replaced by alternative adhering means such as ultrasonic welding, heat fusion, ultraviolet stitcking, adhesives, heat sensitive tapes or any other suitable means for sticking two slats 10 together.

Modifications and variations such as would be apparent to a skilled addressee are deemed within the scope of the present invention.

1. A pleated blind comprising a plurality of flexible tubular fabric slats in which adjacent slats are connected together contiguously in side by side relationship.

2. A pleated blind according to claim 1, wherein the adjacent slats are adhered together.

3. A pleated blind according to claim. 2, wherein the adjacent slats are adhered together by means of adhesive tape.

4. A pleated blind according to claim 2, wherein the width of the adhesive is in the range from 3 to 10 mm.

5. A pleated blind according to claim 4, wherein the width of the adhesive is about 5 mm.

6. A pleated blind according to claim 1, wherein each flexible tubular fabric slat has an endless periphery and does not contain any longitudinal joints.

7. A pleated blind according to claim 1, wherein the flexible tubular fabric slats are formed of polyester fabric.

8. A pleated blind according to claim 1, wherein the pleated blind is able to be flattened and formed into a roll.

9. A pleated blind according to claim 1, wherein the pleated blind is able to be suspended and to expand under the influence of gravity.
